(19) United States
(12) Patent Application Publication
(10) Pub. No.: US 2006/0053997 A1
(43) Pub. Date: Mar. 16, 2006

(54) Cutting device for warp-knitted fabrics

(76) Inventors: Marco Villa, Melzo (IT); Fiorenzo Frassi, Varedo (IT); Franco Puffi, Capriasca (CH)

Correspondence Address: George Pappas, Suite 300, 919 S Harrison Street, Fort Wayne, IN, 46802, US

(21) Appl. No.: 10/544,052

(22) PCT Filed: Jan. 30, 2004
(86) PCT No.: PCT/CH04/00049

§ 371 Date: Sep. 22, 2005

(30) Foreign Application Priority Data
Feb. 3, 2003 (CH) 14803

(51) Int. Cl. B26D 1/00

(52) U.S. Cl. 83/651

(57) ABSTRACT

The cutting device is equipped with a feeding device (10) for a warp-knitted fabric (4). The warp-knitted fabric has at least two warps (6), between which floating weft yarns (8) are placed. The cutting device is also equipped with a cutting implement (22) for cutting through the weft yarns (8) and with a leading away device (24) for the severed warps (6) that serve as effect yarns. In order to improve the cutting device, the cutting implement (22) comprises guide elements (32, 34) with projecting guide edges (36, 38) serving to support the weft yarns (8) to be cut. The guide edges (36, 38) form a gap (40) between them into which a rotating blade (42) extends. The guide elements (32, 34) also contain, on the sides facing away from the guide edges (36, 38), rebouncing guide surfaces (44, 46) for the warps (6).

### TECHNICAL FIELD

The invention relates to a cutting device for warp-knitted fabrics according to the preamble of claim 1. Effect yarns, which are also designated as fancy yarns, can be produced by means of such a cutting device.

### PRIOR ART

Cutting devices of the type initially mentioned are known. In this case, the cutting device is arranged directly on the knitting machine between the knitting head and a band take-up. The cutting devices are equipped either with shears or with a knife. The known cutting devices are, on the one hand, complicated and, on the other hand, difficult to handle and do not provide effect yarns of high quality.

### PRESENTATION OF THE INVENTION

The object of the invention is to improve a cutting device of the type initially mentioned.

The object is achieved, according to the invention, by means of the characterizing features of claim 1.

Since the cutting implement has guide members with projecting guide edges for supporting the weft threads of a warp-knitted fabric which are to be cut, the guide edges forming between them a gap for the engagement of a rotatable knife, an exact guidance of the weft threads to be cut, on the one hand, and a reliable engagement of the rotatable knife, on the other hand, are ensured. In this case, the weft threads are optimally tensioned, in particular, by means of the guide surfaces for the knitted warps, said guide surfaces being set back laterally with respect to the guide edges, and thus assist a satisfactory cutting of the weft threads by the rotatable knife. The cutting device has a simple construction, allows simple operation and provides satisfactory effect yarns.

The cutting device may be integrated in a knitting machine, in which case the feed device and the discharge device may be part of the knitting machine. This is more advantageous however, when the cutting device is designed as an independent unit independently of a knitting machine. The cutting device can then be operated separately from the knitting machine, the advantage of this being that, on the one hand, it is more easily accessible and, on the other hand, optimum utilization becomes possible, since the cutting device can cut substantially more quickly than the knitting machine can knit. An independent cutting device therefore has a substantially higher output than a knitting machine. Moreover, a separate cutting device affords the advantage that the knitting process of a knitting machine is not interrupted by any cutting errors which occur. Furthermore, where a separate cutting device is concerned, there is no need to allow for structural restrictions which are due to an arrangement in a knitting machine.

Advantageous embodiments of the cutting device are defined in claims 2 to 12.

In principle, the guide members of the cutting implement may be designed as sliding bodies past which the warp-knitted fabric to be separated slides. The embodiment as claimed in claim 2 is more advantageous, however, according to which the guide members are designed as rotary bodies which assist the flow of movement of the warp-knitted fabric along the knife. In this case, it is advantageous if those regions of the guide members which are adjacent to the guide edges are designed to prevent slip, that is to say have an antislip region, in order to improve the driving of the guide members designed as rotary bodies. According to claim 3, the antislip region may have a coating consisting of rubber. According to claim 4, an embodiment with a roughened surface or with a rough-coated surface, for example a surface coated with corundum, is also possible. The embodiment as claimed in claim 5 is particularly advantageous, however, according to which the antislip region is provided with a toothed ring. If appropriate, it may be expedient to provide the rotatable guide members with a drive.

The knife may be freely rotatable. It is more advantageous, however, if, according to claim 7 it can be driven by means of a motor at a circumferential speed which is higher than the running speed of the warp-knitted fabric. It may be expedient if the direction of rotation of the rotating knife is opposite to the running direction of the warp-knitted fabric, but a direction of rotation in the running direction of the warp-knitted fabric is more advantageous.

An embodiment of the cutting device as claimed in claim 8 is particularly advantageous, according to which both the feed device and the discharge device have cambered guide members, the setback parts of which serve for receiving the knitted warps. As a result, on the one hand, an optimum feed of the warp-knitted fabric to the cutting implement and, on the other hand, an optimum discharge of the effect yarns obtained by means of the separated warps are possible. These guide members may be sliding guides, but the design as claimed in claim 9 as rotatable guide members is more advantageous. According to claim 10, the feed device is designed as a tension device. According to claim 11, the discharge device expediently has a take-up roller.

A particularly advantageous cutting device is obtained when, as claimed in claim 12, the cutting implement has arranged after it a guide comb which engages between the warps and which can be moved back and forth in a controlled manner transversely with respect to the running direction of the warps. It is thereby possible to control the cutting point along the weft threads so that warps serving as effect yarns and having fringes of varying lengths can be produced. The effect properties of the effect yarns can thus be further varied.

### BRIEF DESCRIPTION OF THE DRAWINGS

Exemplary embodiments of the invention are described in more detail below with reference to the drawings in which:

FIG. 1 shows a cutting device for warp-knitted fabrics in a diagrammatic illustration;

FIG. 2 shows a cutting region of the cutting device in a vertical section transversely with respect to the running direction of the warp-knitted fabric.

### WAYS OF IMPLEMENTING THE INVENTION

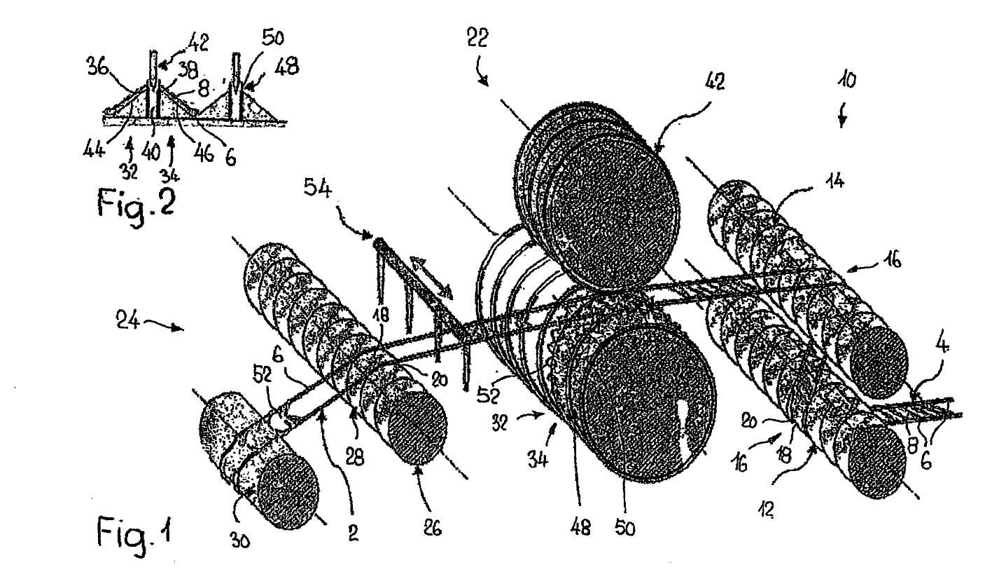

FIGS. 1 and 2 show a cutting device for warp-knitted fabrics 4 for the production of effect yarns 2. The warp-knitted fabric 4 has at least two knitted warps 6, between which floating weft threads 8 are arranged. In the simplest instance, the warp-knitted fabric may consist, as illustrated, of two warps 6 and of weft threads 8 lying between them. As a rule, however, the warp-knitted fabric 4 will have a greater width with numerous warps which are connected to one another by means of floating weft threads.

The warp-knitted fabric 4 is fed via a feed device 10 which is formed by a tension roller 12 and a deflecting roller 14 which in each case have cambered guide portions 16. The weft threads 8 in this case lie above the projecting part 18 and the warps 6 in the setback parts 20. The warp-knitted fabric runs through a cutting implement 22 in which the weft threads 8 are severed, the separated warps then being taken up as effect yarns by a discharge device 24. The latter contains a guide roller 26 with cambered guide portions 28 which are designed in a similar way to the cambered guide portions 16 of the tension roller 12 or of the deflecting roller 14. The effect yarns 2 are then discharged by a downstream take-up roller 30.

The cutting implement 22 contains guide members 32, 34 with projecting guide edges 36, 38 which form between them a gap 40 into which a rotatable knife 42 engages. The knife 42 may be freely rotatable, but is preferably connected to a drive motor, not illustrated in any more detail, which imparts to it a cutting speed, preferably in the running direction of the warp-knitted fabric 4, which is higher than the running speed of the warp-knitted fabric. The guide members 32, 34 are provided, on the sides facing away from the guide edges 36, 38, with setback guide surfaces 44, 46 for the warps 6. The guide members 32, 34 together form a cambered supporting surface for the warp-knitted fabric to be cut. By means of the setback guide surfaces 44, 46, the warps 6 are pre-tensioned into the setback part and thereby tension the weft threads 8 connecting them, across the gap 40, thus affording optimum conditions for satisfactory cutting by the rotating knife 42.

The guide members 32, 34 may be sliding guides, but they are advantageously designed as rotating guide members which are freely rotatable. In this case, it is expedient if the regions adjacent to the guide edges 36, 38 are designed as antislip regions 48, thus assisting the driving of the guide members by the warp-knitted fabric moved past. The antislip region has, for the reliable driving of the guide members 32, 34, a toothed ring 50, the teeth 52 of which engage between the weft threads 8, thereby achieving an optimum driving of the rotatable guide members 32, 34.

The cutting implement has arranged after it a guide comb 54 which engages between the separated warps and which can be moved back and forth in a controlled manner transversely with respect to the running direction of the warps in a way not illustrated in any more detail. It is thereby possible for the warp-knitted fabric which is to be cut to be offset at the guide members laterally within a specific scope, with the result that the cutting point of the knife at the weft threads 8 can be offset. The effect yarns can therefore be produced with fringes 56 of changing length.

### LIST OF REFERENCE SYMBOLS

2 Effect yarn
4 Warp-knitted fabric
6 Warp
8 Weft thread
10 Feed device
12 Tension roller
14 Deflecting roller
16 Cambered guide portion
18 Projecting part
20 Setback part
22 Cutting implement
24 Discharge device
26 Guide roller
28 Cambered guide portion
30 Take-up roller
32 Guide member
34 Guide member
36 Guide edge
38 Guide edge
40 Gap
42 Knife
44 Guide surface
46 Guide surface
48 Antislip region
50 Toothed ring
52 Tooth
54 Guide comb
56 Fringe

1. A cutting device for warp-knitted fabrics, with a feed device for the warp-knitted fabric which has at least two warps, between which floating weft threads are arranged, furthermore with a cutting implement for cutting through the weft threads, and with a discharge device for the separated warps serving as effect yarns, characterized in that the cutting implement has guide members with projecting guide edges for supporting the weft threads to be cut, the guide edges forming between them a gap for the engagement of a rotatable knife, further of the guide members having, on the sides facing away from the guide edges, setback guide surfaces for the warps.

2. The cutting device as claimed in claim 1, characterized in that the guide members of the cutting implement are designed as rotary bodies, at least those regions of the guide members which are adjacent to the guide edges being designed to prevent slip.

3. The cutting device as claimed in claim 2, characterized in that the antislip region has a coating consisting of rubber.

4. The cutting device as claimed in claim 2, characterized in that the antislip region has a roughened or rough-coated surface.

5. The cutting device as claimed in claim 2, characterized in that the antislip region is provided with a toothed ring.

6. The cutting device as claimed in claim 2, characterized in that the rotatable guide members are provided with a drive.

7. The cutting device as claimed in claim 1, characterized in that the rotatable knife is assigned a drive.

8. The cutting device as claimed in claim 1, characterized in that the feed device and discharge device have cambered guide portions, the setback parts of which serve for receiving the warps.

9. The cutting device as claimed in claim 8, characterized in that the guide portions are designed rotatably.

10. The cutting device as claimed in claim 9, characterized in that the feed device is designed as a tension device.

11. The cutting device as claimed in claim 1, characterized in that the discharge device has a take-up roller.

12. The cutting device as claimed in claim 1, characterized in that the cutting device has arranged after it a guide comb which engages between the separated warps and which can be moved back and forth in a controlled manner transversely with respect to the running direction of the warps.

13. The cutting device as claimed in claim 2, characterized in that the rotatable knife is assigned a drive.

14. The cutting device as claimed in claim 2, characterized in that the feed device and discharge device have cambered guide portions, the setback parts of which serve for receiving the warps.

15. The cutting device as claimed in claim 2, characterized in that the discharge device has a take-up roller.

16. The cutting device as claimed in claim 2, characterized in that the cutting device has arranged after it a guide comb which engages between the separated warps and which can be moved back and forth in a controlled manner transversely with respect to the running direction of the warps.

17. The cutting device as claimed in claim 3, characterized in that the rotatable knife is assigned a drive.

18. The cutting device as claimed in claim 3, characterized in that the feed device and discharge device have cambered guide portions, the setback parts of which serve for receiving the warps.

19. The cutting device as claimed in claim 3, characterized in that the discharge device has a take-up roller.

20. The cutting device as claimed in claim 3, characterized in that the cutting device has arranged after it a guide comb which engages between the separated warps and which can be moved back and forth in a controlled manner transversely with respect to the running direction of the warps.
